(19) United States
(12) Patent Application Publication
(10) Pub. No.: US 2010/0221081 A1
(43) Pub. Date: Sep. 2, 2010

(54) SYSTEM FOR AUTOMATION OF FLUCTUATION AND LEVELING OF TOP ROLLERS OF SUGARCANE MILLS

(76) Inventor: Paulo Cesar de Andrade LEITE, Londrina (BR)

Correspondence Address: STITES & HARBISON PLLC, 1199 NORTH FAIRFAX STREET, SUITE 900, ALEXANDRIA, VA, 22314, US

(21) Appl. No.: 12/394,848

(22) Filed: Feb. 27, 2009

(51) Int. Cl. B23Q 1/28

(52) U.S. Cl. 409/64

(57) ABSTRACT

A system for automation of fluctuation and leveling of top rollers of sugarcane mills for use in the automation of the systems of regulation of the pressing elements contained in the milling, preferably but not only, the top rollers of the mills used in distilleries and sugar mills and alcohol, from the implementation of electro-electronic devices that allow monitor and manage the pressure exercised on such rollers.

### FIELD OF INVENTION

The present invention relates to the automation system's hydraulic that controls the fluctuation, leveling, of top roller of sugar and alcohol. In particular controls the pressure and the leveling between the two sides of the top roller.

### BACKGROUND OF THE INVENTION

The mill is an equipment used to grind or crush the sugarcane. Can be installed either individually or together the groups to 08 mills connected in series. Mills consist, of basically three parts: drive, coupling and roller.

The drive is responsible for generating and transmitting the force that will move the milling. Many facilities are known and available for a source drive, such as the steam turbine together with reducing, electric motors together with reducing, hydraulic motors together with reducing.

The couplings is the part that provides the connection to the drive element and at the same time, provides the transmission of force and energy of motion used in the process of rotation of the mills.

The roller is responsible for the crushing of sugarcane and is used to build the mill.

The milling may be composed by two rollers, being one lower roller and one higher roller; three rollers, being one input roller, another output roller and another higher roller; four rollers, being a pre-roller, a roller of entry, a roller-out and a roller top.

The extraction of juice from sugarcane by milling occurs when the cane is directed to the mill and is subjected to successive crushing, in order to obtain the juice and release the bagasse.

To achieve this, all rollers operate simultaneously, but the upper roller, besides rotating, also fluctuates. That is, movement is vertical or at an angle to accept the change in the cane while maintaining a force on this.

There are several factors that can influence the fluctuation of the upper roller, which are: variation of the thickness of the cane, type of drive, type of coupling, the fiber cane, and the speed of rotation of the milling. This fluctuation can cause the rollers to move with the sides leveled or uneven, and are possible because the rollers are set in mobile bearings fitted in the castles, which, in turn, is regulated by hydraulic head pressurized by pump, which compresses the oil until the pressure previously scheduled.

Such programming or adjusting the pressure is done manually, is driven by an electric motor coupled pump that drives the flow of oil and/or fluid to the hydraulic system of the mill, where it is possible to load individual suit by manually actuation of valves.

With this, the rollers remain floating as relieved pressure on heads, through the hydraulic accumulators, which have the function to maintain the level of pressure on those heads and compensate small oil leaks that may exist, and can compensate possible thermal variations and absorb and allow the oscillation of the rollers.

However, the oscillation is not always in a symmetrical way. Therefore beyond the cane, other variables also contribute for an improper suit, such as: mechanical asymmetry between left and right sides of the roller, different fiber cane and rotation of the milling, among others. These variables directly interfere with the way that the top of the roller mill ranges.

In the systems available in the prior art, every time that one of the factors discussed above occurs, human interference is necessary to balance the functioning of the equipment. When the human interference does not occur, several problems may arise such as: mechanical wear on all components of the suits milling and its shareholders, and problem in the extraction of juice, among others.

The regulation systems of the prior art present other shortcomings such as the pressure, which is previously scheduled for limiting the oscillation of the rollers, may change and without being noticed.

In view of the disability and difficulty of maintaining pressure within the mechanical limits, and for optimizing the maximum effort that a suit of mill can generate, in conjunction with the inefficiency of maintaining the appropriate level on both sides of the roller at the time of flotation, the present invention aims to provide mobility to the system. Automated rollers are controlled by electro-electronic devices, which monitor and manage the pressure exercised on the rollers and place the appropriate angle of the rollers when they are in the course of the milling, allowing for compensation of pressure on both sides as the gap occur.

### SUMMARY OF THE INVENTION

The present invention seeks to provide the use and application of devices such as: transducers of pressure and position; block valves equipped with electrical controls; electrical controls which are preferably derived from a programmable logic controller (PLC); hydraulic unit suitable to receive electrical commands, preferably coming from a PLC; and the actual PLC.

In a first aspect the devices are designed to vary the pressure in hydraulic accumulators in an independent way, to meet the needs of displacement of the roller and modify its position and pressure on both sides that are set, and always keep them capped or uneven with hydraulic pressure (PHE) controlled.

In a second aspect the devices are designed to maintain constant pressure in the accumulators of pressure, regardless of oscillations of rollers, while allowing small variations in a way that this acts as an intelligent buffer.

The present invention seeks to provide a system for automation of fluctuation and leveling of top rollers of sugarcane mills characterized by an automatic variation of pressure in hydraulic accumulators independently and maintaining a constant pressure in the pressure accumulator, regardless of oscillations in the time of grinding wheels, by applying the transducer position, pressure transducer, block valve with electric drive, hydraulic unit equipped with electric control, and a programmable logic controller.

The present invention also seeks to provide a system for automation of fluctuation and leveling of top rollers of sugarcane mills characterized by movement of pressing roller mills its given so symmetrical and perpendicular to its axis in an automated manner, as the rates specified by programmable logic controller, consistent with the information transmitted by the transducer position and pressure.

### BRIEF DESCRIPTION OF THE DRAWINGS

FIG. 1 is a diagram of the hydraulic system.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

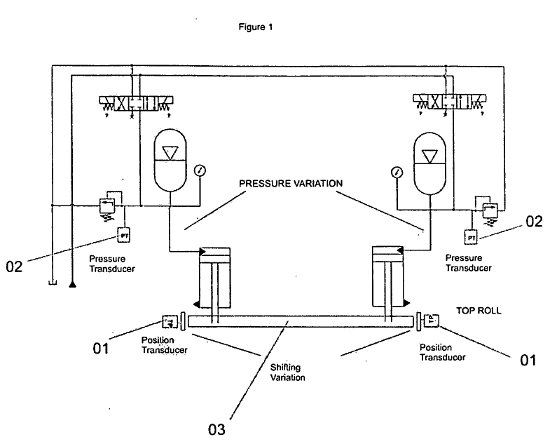

FIG. 1 shows a teaching diagram of the implementation of devices, showing the position transducer (01) measuring the change in the displacement of the roller (03) and pressure transducer (02) measuring the change in hydraulic pressure.

The transducers of position (01) are allocated in roller (03) in order to measure the movement and transmit this information to the PLC. The pressure transducer measures the hydraulic pressure and transmits the information to the PLC. The PLC, in turn, will process the information received and, according to the schedule previously processed, sends the necessary commands to the block valves with electric drive and hydraulic units with electric drive, which perform the task of handling balance perpendicular to the roller (tilt), in conjunction with the pressure necessary for the proper functioning of equipment. The pressure is maintained closest to the set value (set point), allowing small variations, which can be adjusted according to the conditions of each system, not allowing the difference in height between each side of the roller (03) to exceed a predetermined limit. When the difference in height is above the threshold level the system loads or unloads one side, according to the height and pressure of each roller (03). If the roller (03) raises a lot, part of the oil must be discharged for safety reasons, prevent the pressure set up in dangerous conditions.

Having thus described the invention, what is claimed as new and secured by Letters Patent is:

1. A system for automation of fluctuation and leveling of top rollers of sugarcane mills characterized by an automatic variation of pressure in hydraulic accumulators and headstock cylinder independently and maintaining a constant pressure in the pressure accumulator and headstock cylinder, regardless of oscillations in the time of grinding wheels, by applying the transducer position, pressure transducer, block valve with electric drive, hydraulic unit equipped with electric control, and a programmable logic controller.

2. The system for automation of fluctuation and leveling of top rollers of sugarcane mills according to claim 1, characterized by the position transducer measuring the variation of the displacement of the roller mills.

3. The system for automation of fluctuation and leveling of top rollers of sugarcane mills according to claim 1, characterized by a pressure transducer measuring the variation of the hydraulic pressure of the hydraulic system contained in mills.

4. The system for automation of fluctuation and leveling of top rollers of sugarcane mills according to claim 1, characterized by the hydraulic unit installed in mills is equipped to receive electrical controls.

5. The system for automation of fluctuation and leveling of top rollers of sugarcane mills according to claim 1, characterized by block of the valves being installed in mills equipped with electric controls.

6. The system for automation of fluctuation and leveling of top rollers of sugarcane mills according to claim 1, characterized by electrical devices being monitored and managed by the programmable logic controller, and this changing the pressure in hydraulic accumulators.

7. A system for automation of fluctuation and leveling of top rollers of sugarcane mills characterized by movement of pressing roller mills is given so symmetrical and perpendicular to its axis in an automated manner, as the rates specified by a programmable logic controller, consistent with the information transmitted by the transducer position and pressure.
